(19) United States
(12) Patent Application Publication
(10) Pub. No.: US 2006/0009876 A1
(43) Pub. Date: Jan. 12, 2006

(54) Guidance system for a robot

(76) Inventor: Dean McNeil, Sherwood Park (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/148,750

(22) Filed: Jun. 8, 2005

Related U.S. Application Data
(60) Provisional application No. 60/578,418, filed on Jun. 9, 2004.

(51) Int. Cl. G06F 19/00

(52) U.S. Cl. 700/245

(57) ABSTRACT

A guidance system for a robot includes a main monitoring station and an unmanned movable base station, which is in communication with the main monitoring station. A robot is provided which is adapted to operate within a predetermined radius of the base station. Either an umbilical cord connection or a wireless communication link can be provided for dynamically determining the distance and orbital positioning of the robot relative to the base station.

### FIELD OF THE INVENTION

The present invention relates to guidance system for a robot.

### BACKGROUND OF THE INVENTION

A number of robot guidance systems have been patented over the past decade. Examples of prior art robot guidance systems are found in the following U.S. Pat. Nos.: 5,165,064; 5,363,305; 5,378,969; 5,475,600; 5,758,298; 5,911,767; 5,963,663; 6,108,597; 6,124,694. A common problem with these patents is that they are complex and this complexity invariably is reflected in the cost required to build, operate and maintain such a guidance system.

### SUMMARY OF THE INVENTION

What is required is a guidance system for a robot, which is based upon a simple concept and is, therefore, less expensive to build, operate and maintain.

According to the present invention there is provided a guidance system for robots. The guidance system includes a main monitoring station and an unmanned movable base station, which is in communication with the main monitoring station. A robot is provided which is adapted to operate within a predetermined radius of the base station. Means are provided for dynamically determining and monitoring the distance and orbital positioning of the robot relative to the base station and/or the distance and orbital positioning of the base station relative to the robot. As will hereinafter be further described, this can be done through the use of an “umbilical cord” connection with complementary sensing assemblies or through a wireless communication link with complementary sensing assemblies. The umbilical cord connection is appropriate for robots that are working with hoses, as the hoses can serve as the umbilical cord. This will include a robot having a vacuum hose that is engaged in vacuuming or a robot having a hose that is engaged in watering lawns or washing floors. The wireless communication solution will be appropriate in other applications, in which an umbilical cord connection is undesirable. Where a wireless solution is provided, the robot must be capable of operating on battery power. However, where an umbilical cord is used, power can be provided to the robot by bundling a power cord as part of the umbilical cord.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view of a first embodiment of guidance system for a robot constructed in accordance with the teachings of the present invention.

FIG. 2 is a side elevation view, in section, of the base station from the guidance system illustrated in FIG. 1.

FIG. 3 is a side elevation view, in section, of the swivel coupling from the guidance system illustrated in FIG. 1.

FIG. 4 is a front elevation view, in section, of the umbilical cord sensing assembly for the base station from the guidance system illustrated in FIG. 1.

FIG. 5 is a front elevation view of a display at the main monitoring station for the guidance system illustrated in FIG. 1.

FIG. 6 is a side elevation view of a second embodiment of guidance system for a robot constructed in accordance with the teachings of the present invention.

FIG. 7 is a side elevation view, in section, of the base station from the guidance system illustrated in FIG. 6.

### DETAILED DESCRIPTION OF THE PREFERRED EMBODIMENT

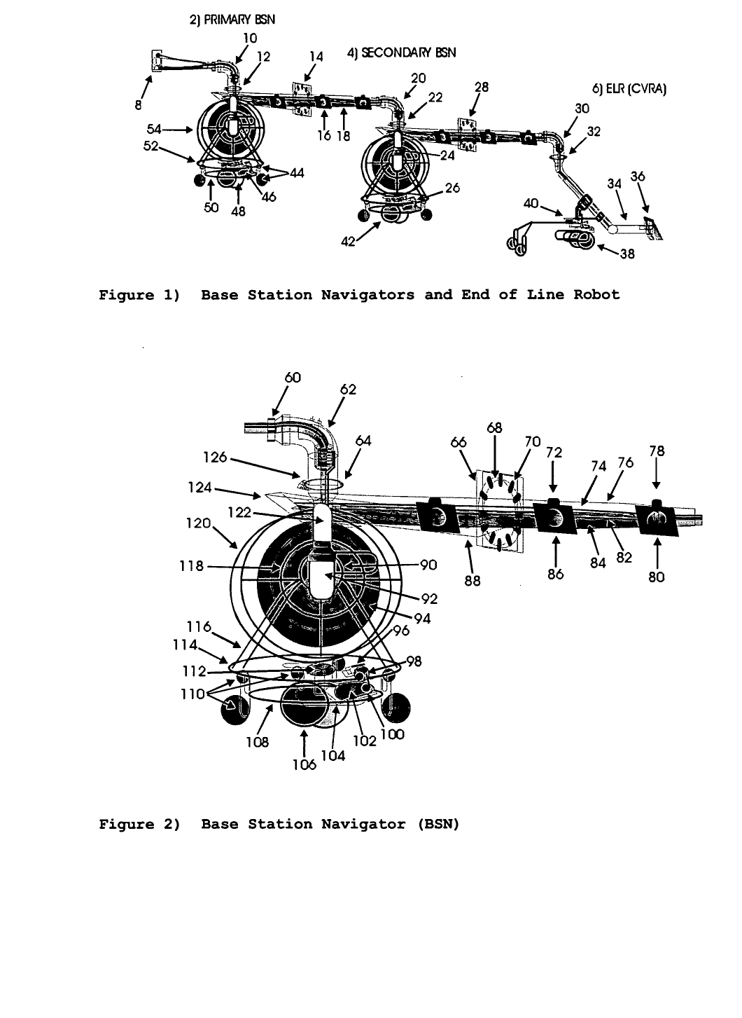

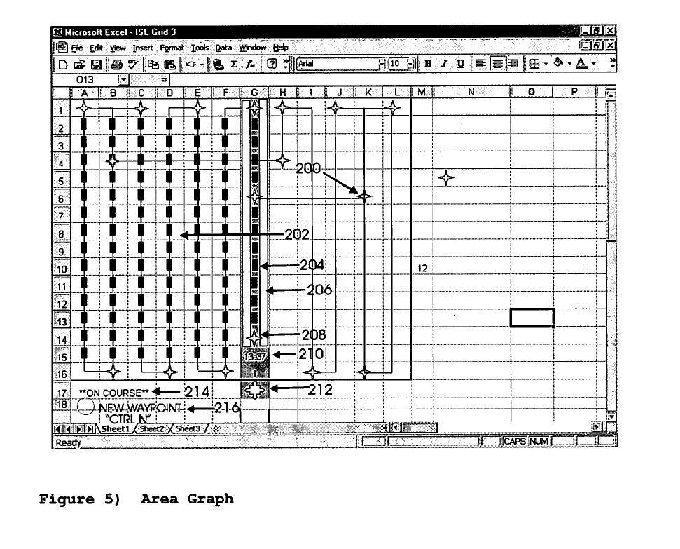

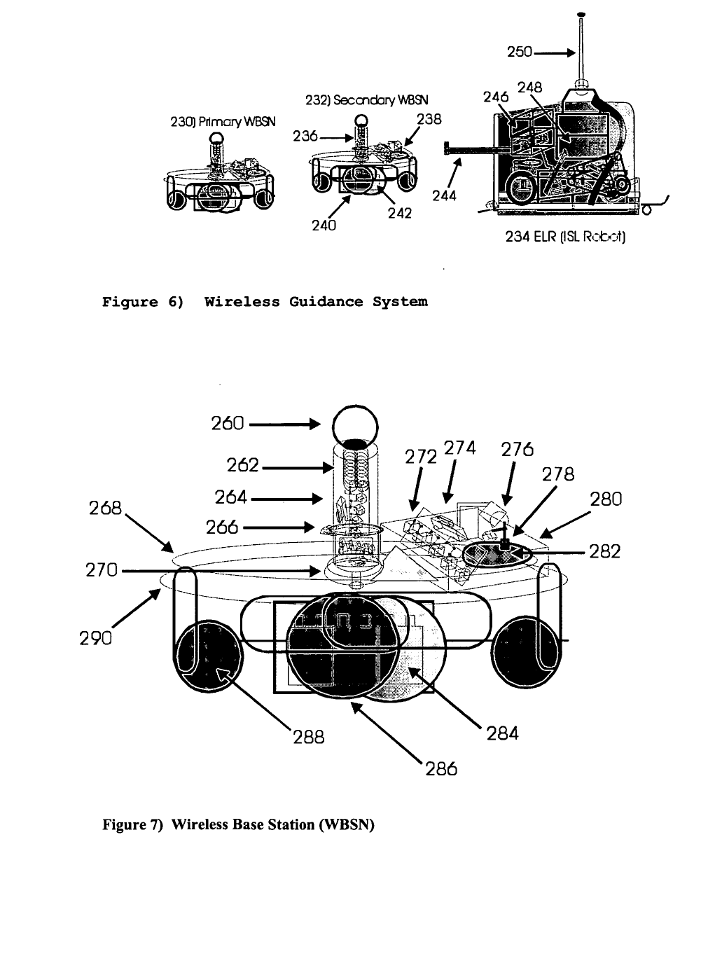

A guidance system for a robot will now be described with reference to FIGS. 1 through 7. A first embodiment of guidance system, generally identified by reference numeral 100, will be described with reference to FIGS. 1 through 5. A second embodiment of guidance system, generally identified by reference numeral 200, will be described with reference to FIGS. 5 and 6.

Definitions

End of Line Robot (ELR #6—FIG. 1)—This is a general term used to indicate the robot being navigated. This could be any type of robot engaged in almost any application. However for simplicity, this system description focuses primarily on robots moving over a relatively flat 2 dimensional surface. Examples of ELR's that have thus far been adapted to operate with this guidance system include a Central Vacuum Robotic Attachment (CVRA) which attaches to a fully functional central vacuum power head unit providing maximum suction and deep cleaning ability; an all in one Ice/Snow/Lawn (ISL) machine also capable of lawn irrigation. The list of machines that can be converted to operate with this guidance system is virtually endless. Basically any machine that can have a drive system installed on it can be navigated with this guidance system. The applications in industry, search and rescue and domestic use are too numerous to mention, and are only limited by ones imagination.

Base Station Navigator (BSN #2,#4—FIG. 1; FIG. 2)—This unit is the central component of the guidance system and is essentially a robot in its own right. It houses the majority of the electronics inside the reel hub (#118—FIG. 2) including the main micro-controller. It is also a power reel, which handles the umbilical cord.(#l 8—FIG. 1) Sensing assembles are incorporated into the BSN to accurately measure the amount of umbilical cord extracted off the reel (#70,#72,#78—FIG. 2). This combined with the RODE (#12, #22, #26, #32, #40, #46—FIG. 1) system (see below) makes this a “Smart Reel”. The entire unit is transported via a two-wheel tank drive system (#42, #48—FIG. 1). The top portion of the BSN, or smart reel pivots by use of the pivot motor (#112—FIG. 2) to follow the orbiting movement of the next in line BSN or ELR.

Relative Orbital Displacement Encoding (RODE)—The measurement of the orbit and the distance or radius of that orbit as related to the BSNs and ELRs (robot separation). This term is used throughout this document to encompass and abbreviate the following definitions, and to accomplish these measurements. Although the physical and electronic design of the RODE can be accomplished in many ways, it is unique in this system description in that it's primary purpose is to function as a main and essential component for the robot guidance system. Two primary RODE designs are utilised in this system description. The first is an optical encoder design and the second is a unique design featuring a robotic computer mouse assembly. One optical encoder RODE (#32—FIG. 1) is located on the umbilical swivel coupling that attaches the umbilical cord to the ELR. This identical optical RODE (#12, #22—FIG. 1; #64—FIG. 2) design is also located on the umbilical swivel coupling on top of the BSN. Another optical RODE (#40—FIG. 1) of slightly different design is implemented in the ELR chassis steering assembly. A Computer Mouse RODE (#26, 46—FIG. 1; #102—FIG. 2) is located in the base of the BSN. The RODE's allow the two machines to navigate in relation to each other in a walking fashion. RODE units of various designs can also be used in several other locations such as measuring and navigating pivotal or swivel joints on the ELR. The concept of the RODE is so essential to this guidance system, that the over all technology can be referred to as RODE technology.

Orbital Radius—The distance of a straight-line measured from the pivot point of the BSN to the current ELR position or visa versa, from the pivot point of the ELR to the current position of the BSN. The Orbital Radius is always measured from the stationary pivot point of the machine that is remaining stationary (pivoting only), as the other machine orbits around it. Orbital Radius will always equal the amount of umbilical cord that is extracted off of the BSN smart reel.

Orbital Angle—This is used in general terms in this document, to describe the angle of relative displacement between the robots current position, and a reference datum extending from the BSN or from the ELR, depending on which RODE position is being measured. The reference datum can be any fixed point along the circumference of an imaginary circle drawn with the current orbital radius. The reference datum used throughout this document is (unless otherwise specified) a line extending from the pivot point of the BSN, to a point on this imaginary circle, where the line represents a given azimuth heading in relation to true north. The BSN calibrates the reference datum on start up, and will confirm this calibration at appropriate positions throughout the course of manoeuvring the robots. A good reference for calibration is a wall with a known compass direction.

Orbital Displacement Vector—The point on a two dimensional plane, where the Orbital angle and the Orbital Radius intersect. This point is the ELR current position in relation to the BSN and/or the BSN current position in relation to the ELR. This position can be represented by both the polar co-ordinates graphing system and the Cartesian plane graphing system.

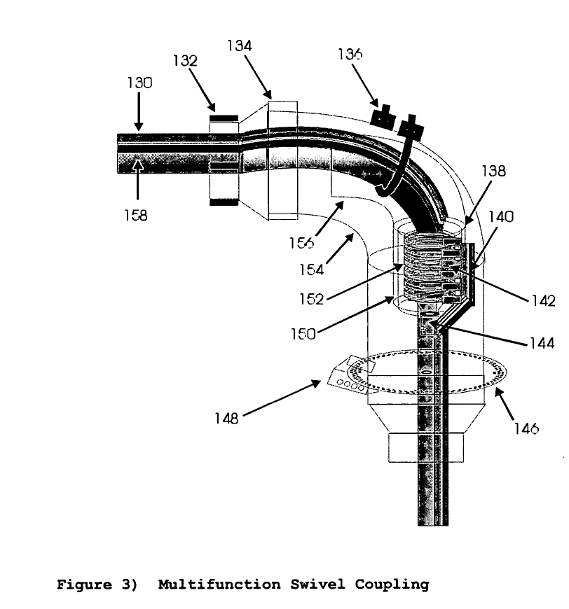

Orbital Encoder—An electronic method incorporated into the RODE to accurately measure the dynamically changing relative orbital angle. There are several methods, which can be used to accomplish this measurement. At the time of this description two methods are predominantly used:
1) Optical Orbital Encoder is a basic flat disc (#12, #22, #32—FIG. 1; #64—FIG. 2) with perforations or holes along the circumference of the disc arranged in a quadratic sequence. These holes allow infrared light to pass through the perforations and to be read by an Infra Red Optical Sensor (IROS #126—FIG. 2; #148—FIG. 3). The disc rotates with the pivot point of the machine, joint, swivel etc., of which RODE measurements are desired and is aligned so as to freely pass through the IROS. The optical encoder functions similar to an optical computer mouse. The design of the optical encoder allows it to be placed in a variety of locations where rotational measurements are required.
2) The computer mouse (#26, #46—FIG. 1; #102—FIG. 2) is mounted on a rotating wheel assembly (#98—FIG. 2) under the BSN, and locked to the rotational movement of the smart reel via a bracket (#104—FIG. 2) so as to rotate with the pivotal movement of the smart reel over the platform disk (#108—FIG. 2) as the ELR or next in line BSN orbits around the BSN. The platform disk is fixed to rotate only with the tank drive chassis. The mouse wheel rotates as evenly spaced (e.g. 1 foot) electronic spacing intervals are detected passing through the sensing assembly. These robotic actions applied to the computer mouse, update the monitoring computer, and therefore track the movement of the robot as it moves around the BSN.

### EMBODIMENT 100

Structure And Relationship of Parts of First Embodiment 100

The Base Station Navigator (BSN FIG. 2) can be utilised to navigate and map the movement of any ELR moving over a relatively flat 2 dimensional surface-area, where an umbilical cord (consisting of power/communication, hoses etc. (#18 FIG. 1; #74, #76, #82, #84—FIG. 2) is implemented. The ELR in this embodiment 100; is not dependent on battery power supply and it has an unlimited supply of fluid to perform its assigned task for much longer periods of time, with less supervision. These are essential features to robots requiring high fluid volumes and unlimited power supply. This cost effective and highly accurate navigation method can be very attractive to any robotic application, even when unlimited power and fluid supply is not the main objective.

The Base Station navigator was originally designed to navigate and supply fluid solution/chemicals to an ice/snow removing machine. This machine is a year round robot, which uses fluids to melt snow and ice and then return the spent fluid through the same hose in the umbilical cord to dispose of, or store and recycle the fluids. In the summer time the machine robotically cuts and then uses a sprinkler system to irrigate lawns. This provides the most even distribution of lawn irrigation, fertilisation and weed control possible, as the robot can be manoeuvred to any and all locations to ensure even and adequate coverage.

In effect, any machine with a cord (such as vacuum cleaners, floor polishers etc.) can be inexpensively modified and equipped with a robotically controlled drive system. Once this is done the base station navigator can robotically control the operation of such a machine. The robot can now be operated by one of three different ways, or a combination of the three. First you can walk behind it and control its movement with manual switches on the control panel. Secondly you can use a remote control to control it without touching the machine. Thirdly with a combination of computer software, and a computer protocol for communication, the robot can be programmed to cover a working area, and perform a desired operation to that working area. This third method or automatic mode requires the base station navigator, which is the main focus of this system description.

The primary BSN (#2—FIG. 1), Secondary BSN (#4—FIG. 1) and ELR's are stored at suitable parking locations when not in use and are transported to various working areas to perform robotic functions within those areas as required. Essentially the primary BSN functions in the same manner as the secondary BSN, except that the secondary BSN is transported more frequently than the primary BSN and is therefore usually of a slightly smaller more compact design. The BSN's are transported via a tank drive (two-wheel drive system) (#42, #48—FIG. 1: #106—FIG. 2). The robot can also be designed to pick up the BSN's and carry them up stairs or over rougher terrain. The BSN's are transported to the desired working areas as pre-programmed into the mapping graph of an entire location layout (e.g.; entire residential yard or house layout). When the guidance system determines that the BSN is in the proper “base position” of a working area a zoomed in graph (FIG. 5), which represents the specific working area within the layout is utilised to obtain more precise guidance acuity. The robot will then perform the programmed route around the secondary BSN, moving the secondary BSN rather frequently to access all areas within the current working area around furniture etc. When each working area is completed, the BSN's and ELR'S are moved accordingly to access the next working area. This process is continued until the ELR has performed its duties to the entire location. A series of ELR's can be used to perform different duties such as vacuuming and/or shampooing carpeted rooms, washing floors, even dusting, cleaning windows and watering houseplants etc. Outdoor ELR's perform such functions as clearing drive ways in winter, cutting lawns in summer, and irrigating the lawn and garden as well.

The umbilical cord is allowed to rotate freely at both ends by using Multifunction Swivel Couplings (see FIG. 3). These swivel couplings allow for the ELR to rotate infinitely around the BSN and the BSN to rotate indefinitely around the ELR, all the time providing on demand/continuous fluid such as water and/or liquid chemicals, hydraulic oil, high pressure air, vacuum air, electric current and electronic communication data to the robot without twisting the attached umbilical cord as one machine orbits around the other. In this design, two distinctly different RODE systems are demonstrated: 1) The Optical Encoder RODE is located directly on the pivot of the swivel coupling and it accurately measures the dynamically changing orbital angle of the swivels. 2) The Robotic Computer Mouse RODE system is mounted at the base of the BSN. This system uses a robotically controlled computer mouse that is primarily used to graphically update a computer monitor so as to visually monitor the robots position and operation at all times. When operating, the Base Station Navigator continuously updates the exact position of the robot to the CPU/micro-controller by dynamically measuring the position of the two RODE systems, which in combination with orbital radius information, electronically represents orbital displacement vectors or current location of the robot and/or BSN. Software and sensing devices (#36—FIG. 1) in communication with these RODE systems can detect when the robot is “OFF COURSE” and will perform a sequence of steering inputs to correct, and keep the robot “ON COURSE” (See FIG. 5, #202, #204, #206). The multifunction swivel coupling (#10, #20, #30—FIG. 1; #62—FIG. 2) is an essential part of the BSN/RODE design, and is articulated in detail in this system description.

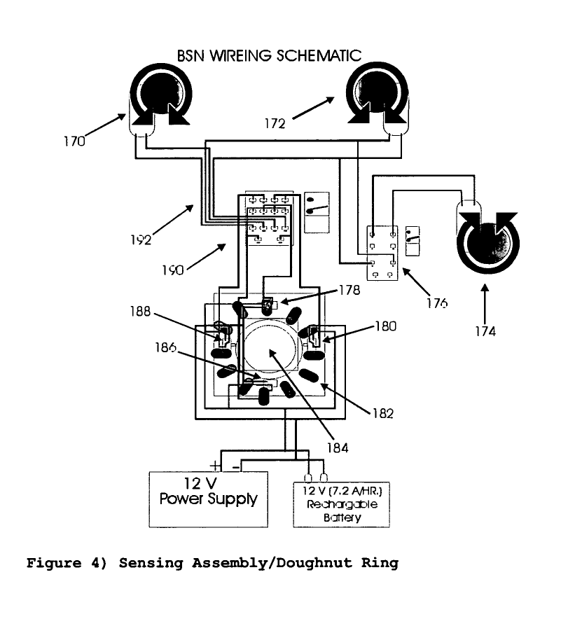

All these requirements must work together in a very effective, concise, accurate and most importantly, safe manner. The concept of the BSN/RODE in its simplest form is to use the robots own umbilical cord to measure the relative and orbital displacement vectors (polar co-ordinates) of the robot in relation to a fixed point. i.e.; the pivot point of the BSN and/or the pivot point of the ELR The RODE encoders are used for taking these measurements and updating the CPU/micro-controller as to the current position of the robot. An aluminium bracket (#88—FIG. 2) extends the umbilical cord Sensing Assembly (#14, #28—FIG. 1; #66—FIG. 2) approximately one-foot from the BSN. This sensing assembly consists of an aluminium housing with 4 contact switches, and a doughnut shaped ring (#68—FIG. 2). The Umbilical Cord travels through the centre of the ring. The contact switches are fixed in position at the top, bottom, left and right sides of the ring. The doughnut ring moves freely inside the housing, and is held in position by the spring-loaded contact switches (see FIG. 4).

The umbilical cord power-reel or smart reel (#120—FIG. 2) on the BSN functions similar to a tethered system. The reel extends and retracts the umbilical cord in order to maintain a predetermined amount of tension on the cord so that the cord is always kept in a straight line from the BSN to the robot. As the robot moves away from the base station (orbital radius increases), the umbilical cord is temporarily under more tension. This action lifts the cord up slightly, which raises the doughnut ring and activates the top tension sensing contact-switch (#178—FIG. 4) on the sensing assembly. This tension-sensing switch energizes a relay circuit, which rotates the reel to extend more umbilical cord.

As the robot continues to move forward, more cord is extended out from the power reel. A series of activation devices such as “plastic clamps” (#16—FIG. 1; #80, #86—FIG. 2), moulded protrusions, or Infra Red (IR) LED's (#72, #78—FIG. 2) are placed on the umbilical cord at fixed intervals (bump on a log concept). The spacing of these activation devices can vary, depending on what degree of accuracy is required. A one-foot spacing is adequate for most robots working over a large area such as a robot engaged in vacuuming a room. For applications, which require extreme accuracy such as soldering electronic PCB boards, the spacing can be in the range of a few millimetres. In this system description the activation devices are IR sensors inserted into a plastic clamp. The clamps are placed on the umbilical cord at one-foot intervals. Theses sensors detect IR light from the IR LED's (#70—FIG. 2; #182—FIG. 4) as they pass through the doughnut ring. The function of these activation devices is to close a spacing interval circuit, when and only when the activators pass through the sensing assembly. The CPU/micro-controller is updated accordingly for the current increasing or decreasing orbital radius, depending on weather the doughnut ring is depressing the top or the bottom contact-switch (as described above) at the time when an activation devise passes through the doughnut ring. Other actions (way-point actions) that occur when this circuit is energized will be discussed later.

Thus, with the aid of some basic trigonometry formulas (algorithm functions) the positions of the secondary BSN, or multiple BSNs and robot in relation to the primary BSN, is accurately represented and interpreted by the CPU/micro-controller. With updated information as to the new direction that the robot faces and then will travel to the next waypoint, after an assigned macro-instruction (robotic movement, to change robot direction), the computer software will perform these algorithm functions and therefore represent on the graph, the actual position of the robot on the actual working area (e.g.; driveway, floor, sidewalk). The computer programming and mathematical calculations will not be discussed in detail at this time. Suffice to say that this is a programming consideration that is mathematically attainable.

As already discussed, when an activation device (IR sensor clamp) passes through the umbilical cord sensing assembly (doughnut) on the BSN, the spacing interval circuit is activated. Another critical action required for the Computer Mouse RODE to function properly is for the system to differentiate between two styles of activation devices. The first style is a standard spacing Interval Activation Device (IAD #16—FIG. 1; #86—FIG. 2), and has already been articulated. The second style is a Waypoint Activation Device (WAD #80—FIG. 2). The function of the WAD is the same as the IAD (i.e. to update orbital radius distance), but it also opens the circuit to the tank drive motors on the ELR, which stops the ELR's current movement. The standard interval clamp has an adjustable screw on it. With the aid of a regular flat screwdriver, an adjustment (90° turn of the screw) can be made which will integrate an additional resistor into the circuit when the IR sensor clamp passes through the doughnut, thus turning an interval clamp into a waypoint clamp, as the CPU/micro-controller is capable of interpreting the voltage difference between the two resulting voltage outputs by use of an analog to digital converter. Yet another option is to use transistors in each IAD, which gives even more unique ID options. These clamps will be referred to as IAD and WAD throughout this system description.

Whenever a WAD is detected, it must instantly stop the movement of the robot. The updated position on the graph has a waypoint button, which will perform a desired movement of the robot (e.g.; 90° Left Turn). Therefore the WAD on the umbilical cord is in synch, with the waypoint buttons. In other words, when a WAD passes through the sensing assembly, it will update the robots position on the graph. That new position on the graph must have a waypoint button. The waypoint button on the graph is actually a series of buttons, arranged in a target configuration. Using a synchronization algorithm, the software is capable of measuring the distance and orbital angle between the actual location of the robot after performing a macro sequence, and the centre of the target on the graph (the desired location). The software will then run a computer-generated sequence of macroinstructions to position the robot over the target centre, and ready for the next programmed macro. As long as the drive wheels on the robot have not slipped while performing the last macroinstructions, this correction for slippage will be minimal.

To instantly stop the movement of the robot, the power circuit to the main drive motor on the robot, must be opened. Therefore communication directly from the base station to the robot, is required. One method utilized to accomplish this on robots requiring continuous fluid flow is an electronic solenoid valve/pulser (#122—FIG. 2) mounted on the base-station. The fluid in the hose is routed through this valve. The valve for the most part remains in the open position (to allow fluid to flow through it). When a WAD is detected, (by a waypoint clamp passing through the sensing assembly), the power circuit to the base station solenoid valve is for an instant opened. This short “off-action” of the solenoid valve will in effect create a pulse wave in the fluid. With a simple pressure-sensing unit on the robot, an electronic circuit will turn the tank drive motors on the robot off instantly, whenever this wave pulse is detected. The momentum of the robot is sufficient to insure that the WAD, completely clears the sensing assembly guides (doughnut ring), and moves to a position where the waypoint screw can easily be accessed. This can also be accomplished with a simple electronic circuit, rather than the fluid wave pulse, however the fluid wave pulse has additional guidance applications, which will not be discussed here.

After the slippage correction is completed, the robot will now remain stationary, as the waypoint button on the graph, performs a pre-programmed macro (set of instructions to the robot) to navigate it to the next waypoint. The computer protocol used for the Computer Mouse RODE at the time of this write up requires a temporary change to the system time on the computer, however more state of the art technology is available to eliminate changing system time, there by reducing or even totally eliminating any idle time where the robot sits and waits for instructions. The currently used computer protocol allows the use of the house wiring (110V) to transmit communication signals to power modules. These modules will then turn on or off any electrical unit (e.g.; electric motor). The software will perform a sequence of module actions at the top of the minute (as determined by the computers internal clock). Therefore, the now stationary robot will remain stationary until the top of the next minute, when the software will perform the macroinstructions for the given time as now set by the waypoint button on the graph. This will turn the robot the desired amount, and then continue on its way with new macroinstructions, until another waypoint is encountered. This detailed sequence of events, is repeated at each waypoint, with specific robot manoeuvring instructions for each waypoint and slippage corrections applied upon reaching each new waypoint. In this manor, an entire working area can be accurately and efficiently covered.

As already mentioned, this short stop interval that must occur for the computer mouse RODE to function properly is because of the software programming used in the monitoring computer. However the orbital encoding RODE has no need for this stop interval to take place. The micro controller in the BSN also acquires information as to how accurately the robot is interpreting its actual position as compared to the ideal mapping position by using the optical encoder RODE. If the micro controller determines that the robots actual position and the desired or mapping position are already in synchronization (the robot is on course), it has the ability to over ride the mouse RODE and therefore eliminate the stop interval. This results in a much smoother operation and reduces or eliminates altogether the need for the stop intervals. As the input sensors, such as bumper whisker contact switches/feelers, sonar systems, optical IR reflective light etc. (#36—FIG. 1) will operate mainly in conjunction with the optical encoder RODE, rather than the computer mouse RODE, the programming code has the ability to logically conclude which RODE must take priority and when, depending on the circumstances encountered. For example a CVRA Robot (Central Vacuum Robotic Attachment) may encounter a temporary obstacle in its path, and have to perform a pre-programmed macroinstruction in order to either manoeuvre around the obstacle or to actually move it. The logic software is capable of taking this into account, and therefore would override the monitoring computers need for a slippage correction should the waypoint location be near or at the location of the temporary obstacle.

Basically the two RODE systems are designed to complement one another, not to work against one another, and this is resolved mainly in the programming code logic. Both systems have their own advantages and disadvantages. The mouse RODE system is a very direct and efficient method to visually graph on the monitoring computer the current position of the ELR and BSN's. This system is also more adaptable to user input variations with the aid of user-friendly software on the average personal computer system. Some of the disadvantages of the mouse RODE system are that it may be more prone to certain operating systems which may lock up and therefore cause all kinds of guidance system problems or may result in complete lose of navigation logic. The orbital encoder RODE on the other hand is much more capable of providing uninterrupted and smother guidance system operations and also “smart features” using sensor arrays etc. However the human input is slightly less user friendly for the average non technical person, and it is a bit more difficult to monitor the progress of the robots on a personal computer system. This guidance system can operate using only one of the RODE's and therefore when both are implemented, they serve as backup for one another. As the system learns more about the environment it is operating in, it becomes more efficient in performing it's navigating tasks and will rely mostly on the optical RODE for uninterrupted macro steering applications, however the mouse RODE system will continuously operate for visual updates, and the mouse RODE system will take priority at key way-point positions (2 per room for example) to ensure and confirm accurate visual updates and navigation should it be required.

Another consideration for the sensing assembly doughnut ring is that the weight of the umbilical cord on the bottom contact-switch would increase as more cord is extracted from the power reel. With no correcting mechanism in place, the contact-switch would always be activated, once the robot was beyond a critical distance away from the BSN (e.g.; more than 20 ft.). To correct for this, a diameter-measuring (#124—FIG. 2) device is built into the housing of the power real. This device will measure the amount of umbilical cord on the real (current diameter), and with the use of a linkage to the sensing assembly bracket, adjust the spring load required to activate the switch. With this correcting mechanism in place the BSN to robot distance can reach lengths of 50 feet or more (100 ft. diameter around the BSN, with an average umbilical cord, consisting of garden and vacuum hoses and power/communication cables) while correctly sensing tension changes in the umbilical cord. One option for longer reach applications is to use more BSN's, which is practical in situations where very accurate navigation is required over longer reaches.

This 50 foot, limitation is only applicable when the robot is required to go out a specified distance, and then execute a waypoint change in direction. If the waypoint change in direction is executed at a point greater than 50 feet, the new direction of the robot movement, would cause the umbilical cord to drag on the ground as it moves in the new direction. To accurately measure a waypoint and keep it in synch with the computer graph, the umbilical cord should remain in a straight line from the BSN to the robot. For large area applications, such as golf course irrigation, the robot can proceed in a straight line from the BSN for a distance only limited by the actual amount of umbilical cord on the power real, and the pulling power of the robot. Also, it can make one or two waypoint corrections beyond the 50 feet limit (e.g.; 1000 feet, with a large power real), in order to access a challenging area, as long as the cord drag on the ground will not interfere with obstacles in the cords path.

Another challenge encountered with using this method of navigating is with small shrubs and bushes such as those on a typical residential lawn, or furniture in a room. There are three possible remedies for this problem. One would be to move the secondary BSN to a new location, in order to access an area behind a shrub for example. For a rather large area, this would probably be preferred to ensure accurate navigation. However, this can become rather time consuming for smaller areas behind such obstacles. The second option is an extension ram on the robot and/or, on the BSN. This ram will physically raise the umbilical cord over the obstacle in order to work on a small area behind such an obstacle. The third option, used especially for vacuuming rooms with furniture, is to use an umbilical cord displacement device. This device is actually a miniature intermediate robot itself. It is located between the BSN and the robot, and with the use of another modified doughnut ring for the cord to travel through, will move along the extended portion of the umbilical cord.

This intermediate robot will actually change the angle of the umbilical cord from the standard straight line to whatever angle would be required for the robot to manoeuvre around an obstacle. The resulting new angle of the umbilical cord will be taken into account in the software calculations, to continue to allow for accurate relative displacement measurements between the BSN and the robot. These devices can also operate independent of the BSN and ELR, and can therefore be used to accomplish such tasks as pre scouting out a room and even moving around furniture in advance of the CVRA for example, and then replacing the furniture when the room is vacuumed. These independent robots can transfer information and communicate with the BSN software via an IR communication device, in order to transfer data back and forth between the two systems. All these robots can also be used in conjunction with security systems to detect any abnormalities in building invasions etc., thus enhancing the functionality of each system.

I built the first ISL (Ice, Snow, Lawn) Robot as an attempt to automate a push reel mower to cut the grass on a putting green. However, the mower could not be set low enough for this application without tearing the fine grass, but it worked great for regular grass. For several years I had the idea to build a machine like a Zamboni only it would remove all ice and snow and not put a new layer of ice on the surface. After the failed attempt at the automated putting green mower I had this machine sitting in the garage just taking up space all winter long. At the beginning of the winter of 2003, an elderly lady in the city of Edmonton was fined for having ice on her sidewalk. 10 minutes after hearing that news I went out to the garage to do something totally unrelated. With this on my mind I happened to look down at this machine, and the idea was born.

Over the course of the winter of 03-04, I built and tested this machine. There were several challenges. The biggest challenge was controlling the umbilical cord. As this was an essential part of the machine, I decided to focus primarily on this area. The idea being that if an umbilical cord must be used anyway, why not use it to it's maximum potential. I needed a navigation system for the robot. I also needed to supply, fluid/chemicals to the robot, and to keep the umbilical from interfering with the robots movements. Therefore the Base Station Navigator, with RODE and multifunction swivel couplings has become the focus of the first patent to be filed and is discussed here in it's entirety.

### Optical RODE Assembly And Function

The Optical RODE (#64—FIG. 2) is the physical assembly or unit housing the Optical Encoder and IROS sensing units (#126—FIG. 2; #148—FIG. 3). Three Optical RODE's are used in this guidance system description. One located on the multifunction swivel coupling of the BSN (#12, #22—FIG. 1). One located on the multifunction swivel coupling of the ELR (#32—FIG. 1) and one on the chassis of the ELR (#40—FIG. 1). This allows the two machines to navigate in relation to each other in a walking fashion. RODE units are also used in various other locations such as measuring and navigating pivotal or swivel joints on the ELR. An electronic method is incorporated into the RODE to accurately measure the dynamically changing relative orbital angle. There are several methods, which can be used to accomplish this measurement but this system description focuses on an optical encoding method. The Optical Encoding Disc is a basic flat disc (#146—FIG. 3) with perforations or holes along the circumference of the disc arranged in a quadratic sequence. These holes allow infrared light to pass through the perforations and be read by an Infra Red Optical Sensor (IROS #148—FIG. 3). The disc rotates with the pivot point of the machine, joint, swivel etc., of which RODE measurements are desired and is aligned so as to freely pass through the IROS.

The contact switches in the doughnut ring are very sensitive, therefore any orbital movement of the umbilical cord immediately activates the pivoting motor (#112—FIG. 2) on the BSN which immediately pivots the smart reel and attached computer mouse until the contact switch is no longer depressed or in other words until the umbilical cord has stopped its orbital movement caused by the movement of the other robot. The shaft of the pivoting motor is permanently fixed or locked to the platform of disk, (#108—FIG. 2) which results in immediate rotation of the smart reel. Because the umbilical cord will always stay is a straight line between the two robots, the swivel has to rotate on the robot that is pivoting as well as the robot that is orbiting. Of course when the swivels move, the optical discs moves with them, and both optical RODES are updated accordingly.

The optical encoding disc (#146—FIG. 3) is designed with a staggered hole configuration on the two outside rows of the discs perimeter. This staggered configuration allows for 144 distinguishable positions or one every 2.5° on a 360° azimuth. The third or inside row of the disc is used to determine the current quadrant the disc is operating in. The quadrant is represented in this third row by a logical sequence of holes unique to each quadrant. 0° or 360°=1 hole, 90°=2 holes, 180°=3 holes, 270°=4 holes. Part of the initial calibration sequence on start up is to verify the current quadrant of operation. Also each time the IROS detects light passing through the holes in the third row, the micro controller is updated accordingly as to the new quadrant of operation. The infrared LED's are enclosed in a protective housing to eliminate any outside light sources, which would interfere with the IROS.

The staggered arrangement of the holes on the two outside rows of the disk, allows for the maximum number of holes to be drilled into the perimeter of the disc. With 144 holes placed every 2.5 degrees apart, the inherent error of the disc works out to approximately 6 inches at a 10 ft orbital radius, 1 foot error at a 20 ft orbital radius, and increases by approximately one foot for every 20 foot increase in the orbital radius. This amount of inherent error is acceptable, as the various sensing assemblies will override any discrepancies. Also as the robots almost always work within a 20 ft radius of each other, the 2.5° hole placement is adequate for most applications.

### Computer Mouse RODE Assembly And Function

As already discussed, when the robot moves away from the base station, the umbilical cord is temporarily under more tension. This action lifts the cord to activate the top contact switch on the doughnut ring. This tension sensing contact-switch (#178—FIG. 4) energizes a relay (#190—FIG. 4), which determines the direction of the small D.C. motor with a rubber wheel (#98—FIG. 2) attached to its drive shaft (approx. 1″ in diameter). As the robot continues to move forward and freely (slight amount of drag is required) pulls the umbilical cord out from the power reel, IAD's and WAD's pass through the doughnut sensing assembly (#14, #28—FIG. 1; #66—FIG. 2). This action rotates the mouse wheel in a clockwise direction, until a stop contact-switch (#96—FIG. 2) is activated by a small protrusion on the mouse wheel.

The computer mouse (#26, #46—FIG. 1; #102—FIG. 2) is attached to this wheel and is adjusted in such a way, as to move the ball of the mouse ahead an exact amount needed to move the computer cursor up (on the y-axis) the computer screen one block, or one cell on the mapping graph (see FIG. 5). When the robots movements take it closer to the base station, the umbilical cord is temporarily under less tension. This will activate the bottom contact switch (#186—FIG. 4) on the doughnut, which causes the exact opposite actions (down on the y-axis) as those listed above, with a result of moving the computer cursor down one block or cell on the graph. As the wheel rotates the mouse, a mouse button clicking mechanism (#100—FIG. 2) is adjusted in such a way, as to click the button one time per wheel revolution. This action highlights the new cell position on the graph.

The stop contact-switch (#96—FIG. 2) is used to stop the rotation of the wheel in such a way as to place the mouse ball fully on the platform disc (#108—FIG. 2). As the ELR moves in a circular motion around the base station, the mouse ball is in constant contact with the platform disk. This results in a horizontal or linear x-axis movement of the cursor over the computer graph. The circle around the pivot point has a radius of aprox. 3″, (the distance from the pivot point to the mouse ball). The circumference of this circle equals the length of the horizontal line (x-axis) that is drawn by the cursor on the computer screen.

The computer mouse is locked to the rotational movement of the smart reel via a bracket (#104—FIG. 2) so as to rotate only with the pivotal movement of the smart reel over the platform disk (#108—FIG. 2), as the smart reel, is pivoted by the pivoting motor. The pivoting motor is controlled by the umbilical cord activating the left or right contact switch on the doughnut ring. This will ensure that the smart reel is always pointing directly at the ELR or the next in line BSN. This of course is necessary, not only for accurate orbital angle measurements, but also to ensure proper wrapping of the umbilical cord as it is extracted and retracted on and off the reel. The platform disk is fixed to rotate only with the tank drive chassis. Without the aid of the pivoting motor, the reel does freely pivot to follow the orbit of the ELR or next in line BSN, but it is not quite efficient enough. Also the tension in the umbilical cord has to be increased. The pivoting motor controlled by the doughnut ring makes this alignment much more accurate and dependable for this guidance system application.

When and only when the BSN tank drive rotates to a new steering position the left and right contact switch of the doughnut ring circuit is also applied to the mouse wheel to lift the mouse up and off of the platform disk. The computer mouse is placed back down on the platform disk when the new tank drive steering position is achieved, so that now as the BSN moves forward with it's new steering position, the graph is updated to once again track the changing orbital angles. This will ensure that the computer mouse always stays directly under the umbilical cord or pointing directly at the next in line BSN or ELR without showing a change in position on the mapping graph when the BSN tank drive is only rotating to a new steering position. The tank drive is linked to the optical RODE for additional steering orientation. As the micro-controller is calibrated to know where the true north reference datum is, all steering inputs are measured in degrees of offset from true north.

Thus, with the aid of some basic trigonometry formulas (algorithm functions) the position of the robot is accurately represented on the graph. The movement of the mouse ball will actually draw the hypotenuse of a right triangle on the computer graph. The derivative sides of the resulting hypotenuse are the actual x and y components representing the actual horizontal and vertical movements of the robot. With updated information as to the new direction that the robot faces and then will travel to the next waypoint, after an assigned macroinstruction, the computer software will perform these algorithm functions and therefore represent on the graph, the actual position of the robot on the actual working area (e.g.; driveway, floor, sidewalk). The computer programming and mathematical calculations will not be discussed in detail at this time. Suffice to say that this is a programming consideration that is mathematically attainable.

### Multifunction Swivel Couplings Assembly And Function (See FIG. 3)

These swivel couplings allow the ELR to rotate infinitely around the BSN and the BSN to rotate indefinitely around the robot, all the time providing on demand/continuous fluid such as water and/or liquid chemicals, hydraulic oil, high pressure air, vacuum air, electric current and electronic communication data to the robot without twisting the attached umbilical cord as one machine orbits around the other. The swivel is an integral design component of the guidance system and when integrated with the RODE becomes the main mechanical component that allows this system to function.

This device performs seven major functions. It Supplies unlimited fluid, vacuum/pressured air, electric power and communications to the BSNs and Robots. It is capable of unrestricted or unlimited swivel action as it supplies these essential requirements. A RODE devise can also be mounted on the outside of the swivel (#146, #148—FIG. 3), for navigation purposes. Even without the RODE, the swivel device has many applications, several of which are useful outside the preferred embodiment of this document. There are many industrial applications for such a device, both within the robotics and automation industries and in other industries as well.

The RODE Swivel device used in this guidance system supplies unlimited water and chemicals to the robot. Other uses would include hydraulic fluid applications etc. At the centre of the swivel unit is a quick-connect (#144—FIG. 3), for water or hydraulic fluid. Heat shrink tubing is fitted over the quick-connect in such a way as to not restrict the rotating movement of the quick-connect. An electric brush and ring system (#142, #152—FIG. 3) is then mounted on the outside of the quick connect. With the metal rings fitting snugly over the heat shrink protected quick-connect. Each ring has a wire (#130—FIG. 3) attached to it and the wires are routed inside the rings between the ring and the heat-shrink, to rotate with the inner assembly. Also each ring is isolated from the other metal rings, with rubber insulators. Spring-loaded carbon brushes each with its own attached wire (#140, #142—FIG. 3), routed to the opposite end of the swivel are fitted into small plastic pipefittings, which house the carbon brushes. These housings are then fitted into a larger plastic pipe (#150—FIG. 3), which fits over the quick-connect and ring assembly. The carbon brushes are aligned and held in place by guides (#138—FIG. 3) and fasteners, so that each brush is in constant and continuous contact with its assigned metal ring as the assembly rotates.

The ring and brush assembly is now placed into a protective housing. In the case of the guidance system application in this system description, the protective housing used is a 3-inch 90° elbow (#154—FIG. 3), which helps to hold the brush housings in place and serves as the mount for the optical RODE. This also provides a chamber (156—FIG. 3) for the vacuum and/or pressured air. Hose's and vacuum pipes are attached to each end and then end caps (#134—FIG. 3) are fitted to complete the assembly.

### Operation of First Embodiment 100

Operating a robot with the umbilical cord RODE BSN system is a relatively uncomplicated procedure. First you need to choose a parking location for the primary BSN. Fluid supply and 120V electric power must be permanently plumed into this location. Once this is done and the robot is manoeuvred to it's parking location using either the control board on the robot, or the hand held remote control, you are ready to program the robot to cover a desired working area.

Programming the Robot

First move the robot forward to pull out the entire length of the umbilical cord. Check each clamp (marked at 1 foot intervals on the umbilical cord), to insure that the adjusting screw(#80, #86—FIG. 2) on each clamp is set to “interval” not “waypoint” position. Now return the robot to the parking location. Using a lap top computer, with the wireless mouse from the BSN plugged into the mouse port, and running the BSN mapping software, open the mapping graph on the laptop computer. Now move the robot forward e.g.; 6 feet by pressing the forward button on either the control board on the robot or on the hand held remote control. Push the stop button. Then adjust the clamp marked 6 feet on the umbilical cord to the “waypoint position” (90° turn of the adjustment screw). On the laptop mapping graph, click “New Way-Point button” (#216—FIG. 5). The robot will physically detach the secondary BSN (if required) and the working area screen will come up on the monitor (laptop computer). The software will store this first waypoint as the BSN location for the new working area.

Now begin to manoeuvre the robot around the perimeter of the desired working area. The software will learn the control inputs for the route between waypoints. At a point furthest away from the BSN location (e.g.; 30 ft.), stop the robot and create a new waypoint, by again adjusting the clamp screw to the waypoint position and clicking the “waypoint” button on the monitor. Continue to manoeuvre the robot back to the BSN location. Again click the waypoint button on the monitor. The software will recognize that this point has already been assigned a waypoint, but as long as at least one other waypoint has been created before returning to this same location, the software will have the robot perform a new set of macroinstructions, to manoeuvre the robot in an entirely different manner from the same waypoint.

Now manoeuvre the robot over the working area in such a way as to cover the entire working area. Try to be as efficient as possible, covering each area only one time. As you are covering the working area, periodically stop the robot and create a new waypoint. The concept of creating waypoints is to ensure accurate tracking of the robot. Therefore, the more waypoints you program into a working area, the more accurate the tracking of the robot will be when it repeats the operation in the auto mode. Some factors to consider when programming the robot to cover a working area are: 1) Complexity of the required movements of the robot. For example the amount of obstacles the robot is required to manoeuvre around. Generally the more obstacles on a working area, the more waypoints are required. A new waypoint must be created to cover a small area behind an obstacle. If a relatively large area must be covered behind an obstacle, it may be more efficient to move the secondary BSN to a new location to cover that working area. 2) Surface traction of the working area. Although the software will over compensate for errors due to robot traction slippage. Generally the more slippery the working area is expected to be, the more waypoints should be programmed for that working area. For example clearing ice and snow from an icy driveway may require twice as many waypoints as cutting grass on a dry lawn. An average working area of say 30 ft.×30 ft on a dry surface, should have about 12 programmed waypoints.

Once you have covered an entire working area (e.g.; cut the lawn and watered the grass), and programmed in the waypoints for that area. You can now return the robot to the BSN location. Manoeuvre the robot to pick up the secondary BSN (if required) or simply transport each machine in a tandem or walking fashion. This action will close that working area on the monitor, and bring up the mapping graph again. Now manoeuvre the ELR and secondary BSN or BSNs to a new working area (any time the secondary BSNs are in transport, the primary BSN will perform the required mapping/navigation of the robot). Manoeuvre the robots to the new working area, and repeat the programming steps for that area. If possible try to use the same waypoint clamps used in other working areas. Of course the software will perform different macro actions, but by using the same clamps the time the robot stops and waits for new macroinstructions at each clamp that has been adjusted to the waypoint position, will be reduced. In this manner an entire complex can be mapped out into these individual working areas.

The control unit also has short cut buttons on it. These buttons will activate various sensors on the ELR's. For example, when operating the CVRA you can push the optical tracking button and the CVRA will automatically track along the edge of the last clean or freshly vacuumed path. This function works best on shag carpets, which reflect rather distinct differences in light between non-vacuumed areas and freshly vacuumed paths. The moisture-tracking button will track along a small moisture line laid down by the last path of the ELR. Other short cut buttons are included on the control units for the ISL to track snow removal and lawn mower paths.

Operating the Robot In Auto Mode

Now return the robot to the parking location. You can now download the waypoint and macroinstruction data to a floppy disk and then up load to your main computer. The laptop is not essential to use, but it can save a lot of walking back and forth to the main computer, when programming waypoints. Once the waypoint data is on the main computer. You can set the time you want the robot to perform in auto mode. The robot will repeat the exact same mapping actions you have programmed. You now have several options. You can have the robot perform operations to any or all of the working areas at the times you specify. You can use the maps you have created and any or all of the waypoints to perform different operations, for example fertilize the lawn once a month.

Several safety factors are incorporated into the BSN system. For example, should the robot wander off an assigned working area, the software will first attempt to return the robot to the BSN location for that working area, and restart the programmed sequence. Should this fail; the robot will physically shut down when ever it goes 1 foot beyond the programmed waypoint perimeter. This occurs whenever a clamp on the umbilical cord beyond the maximum perimeter waypoint clamp for a given working area is sensed. This is why it is important to program the second waypoint for each working area at the furthest point from the BSN. Also the robot is equipped with motion sensors, which will shut it down, should it sense any movement around it, when operating in the auto mode. Also temporary obstacles, which have not been programmed into the working area map, will cause the robot to proceed to the next waypoint when they are encountered, and attempt to continue operation from the next waypoint. When the working area is completed the robot will return to the waypoint previous to where the obstacle was encountered, and attempt to perform the macroinstructions for that waypoint, then return to the BSN and move on to the next working area. You can program the Robot for example, not to water the lawn if an obstacle is encountered on its path.

This Base Station Navigator (BSN), End of Line Robot (ELR) and monitoring station are capable of:
1) Keeping the umbilical cord from interfering with the BSN's and the ELR's movements.
2) Handling a combination of hose and power/communication cords.
3) Being transported to a working area, and now act as a central base station, around which the robot manoeuvres.
4) A computer aided system, to accurately measure the pivoted, rotational movement of the base station (orbital angle), as the robot manoeuvres around the base station and/or the base station manoeuvres around the ELR.
5) A computer aided system, to measure the exact amount of umbilical cord extraction from the BSN (orbital radius).
6) A method of electronically sending these orbital displacement measurements to a CPU/micro-controller.
7) Computer Programming Code to interpret the movements of the ELR and base station, and employ them to update their respective positions.
8) Sensor arrays and circuitry, which interpret and react to surrounding environments and conditional circumstances.
9) Waypoints (robot action points), represented both in the updated CPU/micro-controller chip and on the actual working area, which must always be in sync with each other.
10) Computer Protocol Software to communicate back to the robot, the desired macroinstructions.

### EMBODIMENT 200

Structure And Relationship of Parts of Second Embodiment 200

The preferred method for navigating a robot, using the Wireless Base Station Navigator (WBSN) will now be described with reference to FIG. 6 and FIG. 7.

Another application for the base station navigator would be to take advantage of electronic distance measuring equipment (DME). This electronic measuring would replace the physical way-point/interval clamps and umbilical cord, and greatly simplify the mechanical components, making the BSN a wireless system, referred to as WBSN (Wireless Base Station Navigator) in this embodiment 200. The WBSN would still have to be transported to the base location, would still measure the distance and orbital angle the ELR is in relation to the WBSN. The wireless electronic information transmitted to the WBSN from the ELR, would still control the action of the computer mouse RODE and the optical encoder RODE on the WBSN in the same fashion that the umbilical cord does in embodiment 100. The electronic measuring equipment would, however eliminate the physical need for the umbilical cord. Power Supply would be replaced with a battery pack (#284—FIG. 7) on the robot, and any fluid requirements would require a holding tank (#248—FIG. 6) on the robot. The robot can be programmed to manoeuvre to a refilling/dumping station, to replenish the holding and vacuum tanks. This is not as time efficient as the BSN umbilical cord system, but does give the WBSN system an unlimited fluid supply as well.

The computer protocol would have to be transmitted to the robot with a wireless system, such as “bluetooth”. This method, however would be more expensive, and be more limited in power supply and fluid volumes. The robotic computer mouse action would still be an essential component for navigation.

All the same logic of the system description in embodiment 100 apply to this embodiment 200, but the mechanics are simplified significantly. The electronics however are somewhat more complicated but with state of the art applications, are very conceivable. The concept of the WBSN in its' simplest form is to use DME (Distance Measuring Equipment) to measure where the robots are in relation to each other and in relation to the initial parking location. According to the aspect of the present invention there is provided a method to accomplish these measurements, as well as the requirements mentioned above. A wireless computer mouse (#282—FIG. 7) and optical encoder are the main components for taking these measurements in both the x and y axis's, and for sending the movement of the mouse and optical encoder to the CPU/micro controller.

Differential GPS for example is accurate within +/−10 centimetres, and is one comparatively inexpensive option for the DME requirements of this application. Other methods to supply orbital radius and orbital angle information would include the use of loop antennas sonar, and other such devices. An electronic sensing assembly (#280—FIG. 7) comprising of a computer chip (#274—FIG. 7) and associated electronics robotically controls the action of a wireless computer mouse (#282—FIG. 7) which is the main component for taking measurements in both the x and y axis's, and for sending the movement of the mouse to the computer monitoring station. The physical clamps illustrated in embodiment 100, are replaced by electronic voltage inputs, as created by the DME receiver (#236—FIG. 6, #262—FIG. 7) on the WBSN. An electronic computer chip and associated electronics (#264—FIG. 7) are employed to interpret the DME information. This chip is capable of dynamically sensing the exact distance and orbital angle of the robot in relation to the WBSN, at all times. By comparing a series of “DME Surveys” taken at for example one-second intervals, the chip can interpret when the robot is moving closer or further away from the WBSN. For illustration purposes in this embodiment, DME surveys, which determine that the robot to WBSN distance is increasing, will be referred to as SDI (Survey Distance Increasing) and DME surveys, which determine that the robot to WBSN is decreasing, will be referred to as SDD (Survey Distance Decreasing).

As the robot moves away from the base station, the SDI surveys stored in the chip will energize a relay (#274—FIG. 7), which determines the direction of a small D.C. motor with a rubber wheel attached to its drive shaft (approx. 1″ in diameter). As the robot continues to move away from the robot (SDI surveys continue) the spacing interval circuit will be activated, (close-circuit) once for every 1 foot of distance change, for example. This action rotates the mouse wheel (#276—FIG. 7) in a clockwise direction, until a stop contact-switch is activated by a small protrusion on the mouse wheel. The computer mouse is attached to this wheel and is adjusted in such a way, as to move the ball of the mouse ahead an exact amount needed to move the computer cursor up (on the y-axis) the computer screen one block, or one cell on the mapping graph. When the robots movements take it closer to the base station, the SDD surveys causes the exact opposite actions (down on the y-axis) as those listed above, with a result of moving the computer cursor down one block or cell on the graph. As the wheel rotates the mouse, a mouse button clicking mechanism (#278—FIG. 7) is adjusted in such a way, as to click the button one time per wheel revolution. This action highlights the new cell position on the graph. Other actions (waypoint actions) that occur, on the mouse click action, will be discussed later.

In this embodiment the DME assembly is capable of determining the orbital direction the ELR is in relation to the WBSN and Visa Versa by the use of a loop antenna assembly. A DC motor mounted at the base of the DME assembly (#270—FIG. 7) rotates the robotic mouse assembly (#282—FIG. 7) and optical encoder RODE (#266—FIG. 7) so as to always point them directly at the ELR transmitting antenna (#250—FIG. 7—ISL Robot). The stop micro-switch is used to stop the rotation of the wheel in such a way as to place the mouse ball on the platform disc (#268—FIG. 7) of the base station.

As already discussed, the DME will activate the spacing interval micro switch at 1-foot intervals, to update the robots position on the monitor. Another critical action required is for the DME system to be programmed so that it is in synch with the macro waypoints on the computer graph. This is somewhat simplified with the WBSN, as the computer monitoring station is now in direct communication with both the WBSN DME and the robot. The waypoints will be programmed into the computer by manipulating the robot over the working area using an electronic control board on the robot. Each steering input is automatically stored as a macroinstruction in the computer, and is assigned to the last programmed waypoint. Which allows for a virtual “playback” or auto mode, where the robot will perform the exact same route as was programmed in during the manual operation. Continuous smaller waypoint corrections will be made to keep the robot in synch, or on track when in playback mode.

It will no longer be critical to stop the robot at each waypoint, and wait for a macro operation. This will result in a much smoother operation than discussed in embodiment 100, and slightly more time efficient. Also the reach of the robot, or maximum distance it is capable of operating from the WBSN is unlimited. However the WBSN must be within a maximum distance of approximately 70 feet from the computer as this is the maximum range of the wireless computer mouse.

Another practical application related to this embodiment would be the use of projected, or computer generated base station locations. This is commonly used in the navigation of aircraft, where the electronics of a GPS system, for example, is used to generate a “waypoint” a desired distance, and on a specific radial or vector from a navigation beacon and you can now track to that location, with the same instrument indications as you would have if the “waypoint” was an actual beacon. In this application the WBSN would work the same as already articulated, with the exception that it's actual physical location could be any-where (e.g.; indoors, right beside the computer, assuming good GPS reception-antenna required). The electronics would “project” a desired base location on the computer graph/working area, and the BSN now physically sitting at a different location, would perform as though it were actually at that projected base location (always orientated to or pointing to the robot from that projected location). This would require slightly more sophisticated programming and electronics, but these have been available for a long time now, and are actually becoming quite reasonable in price and dependability. The advantage of this WBSN application would be that the Secondary WBSN would not have to be transported to the various working locations.

### Operation of Second Embodiment 200

Operating a robot equipped with a WBSN is a relatively uncomplicated procedure. First you need to choose a parking location for the robot. This will be the permanent location of the primary WBSN. Fluid supply and electric power must be self-contained on the robot itself. Once this is done and the robot is manoeuvred to it's parking location using either the control board on the robot, or the hand held remote control, you are ready to program the robot to cover a desired working area.

Programming the Robot

Using a lap top computer, with the wireless mouse from the BSN plugged into the mouse port, and running the WBSN mapping software, open the mapping graph on the laptop computer. Now move the robot forward e.g.; 6 feet by pressing the forward button on either the control board on the robot or on the hand held remote control. Push the stop button. On the laptop mapping graph, click “New Way-Point button”. The robot will physically detach the secondary BSN (if required) and the working area screen will come up on the monitor (laptop computer). The software will store this first waypoint as the BSN location for the new working area.

Now begin to manoeuvre the robot around the perimeter of the desired working area. At a point furthest away from the WBSN location (e.g.; 30 ft.), stop the robot and create a new waypoint, by clicking the “New Waypoint” button on the monitor and on the WBSN DME. Continue to manoeuvre the robot around the remaining perimeter and back to the WBSN location. Again click the new waypoint button on the monitor. The software will recognize that this point has already been assigned a waypoint, but as long as at least one other waypoint has been created before returning to this same location, the software will have the robot perform a new set of macroinstructions, to manoeuvre the robot in an entirely different manner from the same waypoint.

Now manoeuvre the robot over the working area in such a way as to cover the entire working area. Try to be as efficient as possible, covering each area only one time. As you are covering the working area, periodically stop the robot and create a new waypoint. The concept of creating waypoints is to ensure accurate tracking of the robot. An average working area of say 30 ft.×30 ft on a dry surface, should have about 12 programmed waypoints.

Once you have covered an entire working area (e.g. cut and watered the lawn), and programmed in the waypoints for that area. You can now return the robot to the WBSN location. Manoeuvre the robot to pick up the secondary WBSN if required. This action will close that working area on the monitor, and bring up the mapping graph again. Now manoeuvre the robot to a new working area (any time the secondary WBSN is in transport by the robot, the primary WBSN will perform the required mapping/navigation of the robot). Manoeuvre the robot to the new working area, and repeat the programming steps for that area. In this manner an entire complex can be mapped out into these individual working areas.

Now return the robot to the parking location. You can now download the waypoint and macroinstruction data to a floppy disk and then up load to your main computer. The laptop is not essential to use, but it can save a lot of walking back and forth to the main computer when programming waypoints. Future designs will eliminate the need to use the laptop computer. Once the waypoint data is on the main computer, you can set the time you want the robot to perform in auto mode. The robot will repeat the exact same mapping actions you have programmed. You now have several options. You can have the robot perform operations to any or all of the working areas at the times you specify. You can use the maps you have created to perform different operations, for example fertilize the lawn once a month.

Several safety factors are incorporated into the WBSN system. For example, should the robot wander off an assigned working area, the software will first attempt to return the robot to the WBSN location for that working area, and restart the programmed sequence. Should this fail; the robot will physically shut down when ever it goes 1 foot beyond the programmed waypoint perimeter or when the GPS signal is interrupted. This is why it is important to program the second waypoint for each working area at the furthest point from the WBSN. Also the robot is equipped with motion sensors, which will shut it down, should it sense any movement around it, when operating in the auto mode. Also temporary obstacles, which have not been programmed into the working area map, will cause the robot to proceed to the next waypoint when they are encountered, and attempt to continue operation from the next waypoint. When the working area is completed the robot will return to the waypoint previous to where the obstacle was encountered, and attempt to perform the macroinstructions for that waypoint, then return to the WBSN and move on to the next working area. You can program the Robot for example, not to water the lawn if an obstacle is encountered on its path.

This Wireless Base Station Navigator (WBSN), End of Line Robot (ELR) and monitoring station are capable of:
1) Being transported to a working area, and now act as a central base station, around which the robot manoeuvres.
2) A computer aided system, to accurately measure the pivoted, rotational movement of the base station (orbital angle), as the robot manoeuvres around the base station and/or the base station manoeuvres around the ELR.
3) A computer aided system, to measure the Orbital Radius.
4) A method of electronically sending these orbital displacement measurements to a CPU/micro-controller.
5) Computer Programming Code to interpret the movements of the robot and base station, and employ them to update their respective positions.
8) Sensor arrays and circuitry to interpret and react to surrounding environments and conditional circumstances.
9) Waypoints (robot action points) with associated macroinstructions, represented both in the updated CPU/micro-controller chip and on the actual working area, which must always be in sync with each other.
10) Computer Protocol Software to communicate back to the robot, the desired macroinstructions.
   Description of the Labels
   FIG. 1

2) Primary BSN

4) Secondary BSN

6) ELR (CVRA)

8) Outlet (Vacuum/110VPower/Water)

10) Multifunction Swivel Coupling

12) Optical RODE Disk

14) Sensing Assembly (Doughnut Ring)

16) Interval Spacing/Waypoint Clamps

18) Umbilical Cord

20) Multifunction Swivel Coupling

22) Optical RODE Disk

24) Multifunction Swivel Coupling

26) Computer Mouse RODE Assembly

28) Sensing Assembly (Doughnut Ring)

30) Multifunction Swivel Coupling

32) Optical RODE Disk

34) Central Vacuum Power Head

36) Bumper with Light Sensing Assembly

38) Tank Drive Assembly

40) Optical RODE Disk (Steering Mechanism)

42) Tank Drive Assembly

44) Castor Wheels (Top and Bottom)

46) Computer Mouse RODE Assembly

48) Tank Drive Assembly

50) Platform Disk for Computer Mouse

52) Smart Reel Base

54) Smart Reel

FIG. 2

60) End Cap (IR Port Sensing assembly)

62) Multifunction Swivel Coupling

64) Optical RODE Disk

66) Sensing Assembly (Doughnut Ring Housing)

68) Doughnut Ring

70) Infra Red LED's

72) Infra Red Sensor (High Voltage-IAD Setting)

74) Power Cord (3 wires)

76) Vacuum Hose

78) Infra Red Sensor (Low Voltage-WAD Setting)

80) Waypoint Activation Device (WAD) Set to Waypoint Position

82) Communication Bundle (4 wires)

84) Garden Hose

86) Interval Activation Device (IAD) Set to Interval Position

88) Sensing Assembly Extension Bracket

90) Smart Reel Drive Motor

92) Multifunction Swivel Coupling (+ reel axial)

94) Umbilical Cord (40 ft. typical)

96) Mouse Wheel Stop Sensing Contact Switch

98) Small DC Motor and wheel assembly (mouse wheel)

100) Computer Mouse Button-Clicking Mechanism

102) Computer Mouse

104) Computer Mouse Alignment Bracket

106) Two-Wheel Tank Drive

108) Computer Mouse Platform Disk

110) Castor Wheels (Top and Bottom)

112) Pivoting Motor (on #114/mortor's shaft on #102)

114) Smart Reel Base

116) Smart Reel Frame

118) Smart Reel Hub (Houses Electronics and #90)

120) Smart Reel

122) Electronic Solenoid Valve/Pulser

124) Diameter Measuring Device (measures the amount of umbilical cord remaining on the smart reel)

126) Infra Red LED/Sensor for Optical RODE Disk

FIG. 3

130) Communication/Power Cables from Rings

132) IR LED's for Auto Port to Wall Outlet

134) EndCap

136) Clamp

138) Brush/Ring Alignment Guide

140) Communication/Power Cables from Brushes

142) Carbon Brushes

144) Quick Connect-Bayonet Style

146) Optical Disk

148) Optical Disk IR LED/Sensor Unit

150) Brush Housing

152) Rings w/insulators

154) 3 inch 90° Elbow

156) Vacuum Chamber

158) Garden Hose

FIG. 4

170) Left Wheel Assembly

172) Right Wheel Assembly

174) Pivoting Motor

176) Pivoting Motor Relay

178) Top Contact Switch

180) Right Contact Switch

182) Infrared LED's (to detect IAD/WADs)

184) Doughnut Ring

186) Bottom Contact Switch

188) Left Contact Switch

190) Tank Drive Relay

192) Motor Wires

FIG. 5

200) Waypoint Button

202) ELR Path

204) On Course Button

206) Off Course Button (long rectangle, on each side)

208) Initial Waypoint

210) System Time of Computer

212) ELR Parking Location/Reset Button

214) On Course/Off Course Indicator

216) New Waypoint Button

FIG. 6

230) Primary WBSN

232) Secondary WBSN

234) End of line Robot (ELR/ISL)

236) DME Transmitter/Receiver Antenna (WBSN)

238) Wireless Computer Mouse

240) Two Wheel Tank Drive Assembly

242) Battery Pack

244) Transport Hitch

246) ISL Battery

248) Fluid Holding Tank

250) Transmitter/Receiver Antenna (ISL)

FIG. 7

260) WBSN Carrying Hook

262) DME Receiver/Transmitter Assembly (Loop Antenna)

264) DME Chip and associated Electronics

266) Optical RODE Assembly

268) DME Base

270) Pivoting Motor

272) Computer Mouse Electronics

274) Computer Mouse Wheel Relay

276) Computer Mouse Wheel and Motor

278) Computer Mouse button clicking assembly and attaching rod

280) Robotic Mouse Assembly and electronics Housing

282) Wireless Computer Mouse

284) Battery Pack

286) Tank Drive Assembly

288) Castor Wheels

290) Computer Mouse Platform Disk

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A guidance system for a robot, comprising:
a main monitoring station; an unmanned movable base station which is in communication with the main monitoring station; a robot adapted to operate within a predetermined radius of the base station; and means for dynamically determining the distance and orbital positioning of the robot relative to the base station.

2. The guidance system for a robot as defined in claim 1, wherein the means for dynamically determining the distance and orbital positioning of the robot relative to the base station includes an extendible and retractable umbilical cord which extends between the robot and the base station, a first sensing assembly to determine a length of umbilical cord which has been extended from the base station and a second sensing assembly being provided to determine an orbital position of the robot relative to the base station.

3. The guidance system for a robot as defined in claim 1, wherein the means for dynamically determining the distance and orbital positioning of the robot relative to the base station includes a wireless communication link between the robot and the base station, with a first sensing assembly to determine a distance the wireless signal from the robot is from the base station and a second sensing assembly being provided to determine an orbital position the wireless signal from the robot is relative to the base station.

4. The guidance system for a robot as defined in claim 1, wherein the means for dynamically determining the orbital positioning of the robot relative to the base station includes a swivel coupling with an orbital encoder and software in communication with the orbital encoder which is adapted to perform relative orbital displacement encoding.

5. The guidance system for a robot as defined in claim 2, wherein the first sensing assembly includes a plurality of interval activation devices positioned at spaced intervals along the umbilical cord.

6. The guidance system for a robot as defined in claim 3, wherein the first sensing assembly includes distance measuring electronics adapted to perform distance measurement surveys.

7. The guidance system for a robot as defined in claim 1, wherein the robot is programmed to navigate between waypoints and waypoint activation electronics are provided that initiate macroinstructions upon the robot reaching the waypoints.

8. The guidance system for a robot as defined in claim 2, wherein the robot is equipped with an extension ram, which is adapted for lifting the umbilical over obstacles.

9. The guidance system for a robot as defined in claim 2, wherein a tension sensor is provided which is adapted to sense the tension in the umbilical cord, the tension sensor being connected to a reel which feeds the umbilical cord out when tension in the umbilical cord is sensed and reels the umbilical cord in when slack in the umbilical cord is sensed.

10. The guidance system for a robot as defined in claim 9, wherein the tension sensor has an upper contact switch which is contacted by the umbilical cord when the umbilical cord is in tension and a lower contact switch which is contacted by slack in the umbilical cord.

11. A guidance system for a robot, comprising:
a main monitoring station;
an unmanned movable base station which is in communication with the main monitoring station;
a robot adapted to operate within a predetermined radius of the base station;
a reel mounted extendible and retractable umbilical cord which extends between the robot and the base station, the reel having a drive motor;
a tension sensor adapted to sense the tension in the umbilical cord, the tension sensor being connected to the drive motor for the reel, the drive motor feeding the umbilical cord out when tension in the umbilical cord is sensed and reeling the umbilical cord in when slack in the umbilical cord is sensed;
a first sensing assembly to determine a length of the umbilical cord which has been extended from the base station including a plurality of interval activation devices and waypoints activation electronics being positioned at spaced intervals along the umbilical cord, the robot being programmed to navigate between waypoints, the waypoint activation electronics initiating macroinstructions upon the robot reaching the waypoints; and
a second sensing assembly being provided to determine an orbital position of the robot relative to the base station, including a swivel coupling on the base station with an orbital encoder and software in communication with the orbital encoder which is adapted to perform relative orbital displacement encoding.

12. The guidance system for a robot as defined in claim 11, wherein the robot is equipped with an extension ram, which is adapted for lifting the umbilical over obstacles.

13. The guidance system for a robot as defined in claim 11, wherein the tension sensor has an upper contact switch which is contacted by the umbilical cord when the umbilical cord is in tension and a lower contact switch which is contacted by slack in the umbilical cord.
